(19) United States
(12) Patent Application Publication
(10) Pub. No.: US 2009/0288688 A1
(43) Pub. Date: Nov. 26, 2009

(54) NON-CORROSIVE CHEMICAL RINSE SYSTEM

(76) Inventors: Ron Rulkens, Milpitas, CA (US); Igor Ivanov, Danville, CA (US); Mark Weise, Fremont, CA (US)

Correspondence Address: LAW OFFICES OF MIKIO ISHIMARU, 333 W. EL CAMINO REAL, SUITE 330, SUNNYVALE, CA, 94087, US

(21) Appl. No.: 11/276,728

(22) Filed: Mar. 11, 2006

Related U.S. Application Data
(60) Provisional application No. 60/661,197, filed on Mar. 11, 2005.
(60) Provisional application No. 60/596,716, filed on Oct. 14, 2005.

(51) Int. Cl. B08B 3/08; C09K 13/00

(52) U.S. Cl. 134/99.1; 134/109; 134/110; 252/79.1

(57) ABSTRACT

A rinse system including providing a chemical rinse including a corrosion inhibitor, and rinsing a wafer with the chemical rinse reducing defects on silicon and a dielectric, and maintaining integrity of a metal.

### CROSS-REFERENCE TO RELATED APPLICATIONS

This application claims the benefit of U.S. Provisional Patent Application Ser. No. 60/661,197 filed Mar. 11, 2005, and the subject matter thereof is hereby incorporated herein by reference thereto.

This application also claims the benefit of U.S. Provisional Patent Application Ser. No. 60/596,716 filed Oct. 14, 2005, and the subject matter thereof is hereby incorporated herein by reference thereto.

### TECHNICAL FIELD

The present invention relates generally to chemical rinse systems and more particularly to non-corrosive chemical rinse systems.

### BACKGROUND ART

As integrated circuits become ubiquitous, demands grow for smaller, higher performing and lower cost devices. These demands continue to require improvements in the integrated circuit manufacturing processes. To produce the desired integrated circuits, processes must provide higher quality including improved cleaning. As smaller particles and the effects of cleaning on the desired materials become less tolerable, more complete cleaning while reducing the corrosive effects of cleaning has become increasingly important. Manufacturing processing including photoresist, etching, and planarization, all produce materials and particles that must be removed for further processing. Failure to remove the unwanted materials and particles contaminates the integrated circuits, preventing proper functioning and reliability of the integrated circuit devices.

An integral part of integrated circuit fabrication is the formation of metal lines and vias. Photoresist is used to transfer an image to the desired circuit layer. After the desired image transfer has been achieved, an etching process is used to form the desired structures. The metal lines are used to form electrical connections between various parts of the integrated circuit that lie in the same fabrication layer. The metal lines are often leveled or planarized to provide a more consistent surface for further processing. The vias are holes that are etched through dielectric layers and later filled with a conductive metal. These are used to make electrical connections between different vertical layers of the integrated circuit. After the etching process has been completed, the photoresist and metals particles should be removed. Unfortunately, the etching processes produce insoluble metal-containing residues that are not easily removed.

Many different rinses using a wide variety of chemicals have been attempted to clean the wafers containing the integrated circuits. From very complicated chemistries to simple rinses, many manufacturers have attempted to solve the cleaning issues. In the past, de-ionized or carbonated water was used for cleaning thin metal containing surfaces during semiconductor manufacturing. Often, a final rinse of de-ionized or carbonated water is used to wash off particles from metal or dielectric areas of a semiconductor wafer that are the result of processing the semiconductor wafer, during either pre-metal or post-metal processing operations used during semiconductor processing.

It is challenging to rinse very thin, 0.001-100 nm metal film (copper, cobalt, tungsten, aluminum, the metals mentioned later), and films without corroding the metal film. Water or most water or acidic water based solutions often corrode the metal resulting in reduced film thickness, pitting, and residue or particles that are left on the film surface after processing. This results in yield losses in microelectronic device manufacturing

However, de-ionized water corrodes certain metals such as copper (Cu) and cobalt (Co) restricting the rinse time, limiting particle performance of the process, and resulting in relatively high metal contamination on dielectric surfaces on patterned wafers, where the surface is composed of a combination of metal and dielectric materials. Carbonated water has the disadvantage of being acidic, resulting in high affinity of the wafer surface to particles. Particles from some processing materials, such as photoresist, can precipitate out of an acidic rinse, such as carbonated water. The carbonated water also has the disadvantage of very limited capacity due to limitations of carbon dioxide solubility in water.

Both effective cleaning and limiting corrosion are critical to providing improved density and performance of integrated circuits. Across virtually all applications, there continues to be growing demand for reducing size, increasing performance and lower costs of integrated circuits. The seemingly endless demands are no more visible than with products in our daily lives. Smaller and denser integrated circuits are required in many portable electronic products, such as cell phones, portable computers, voice recorders, etc. as well as in many larger electronic systems, such as cars, planes, industrial control systems, etc. As the demand grows for smaller electronic products with more features, manufacturers are seeking ways to improve manufacturing processes for the integrated circuit. To meet these needs, manufacturers continue to seek improved processes to reduce contaminants and corrosion.

Thus, a need still remains for a rinse system to provide improved cleaning and reduced corrosion. In view of the increasing demand for improved integrated circuits and the electronic products containing them, it is increasingly critical that answers be found to these problems.

Solutions to these problems have been long sought but prior developments have not taught or suggested any solutions and, thus, solutions to these problems have long eluded those skilled in the art.

### DISCLOSURE OF THE INVENTION

The present invention provides a chemical rinse including a corrosion inhibitor, and rinsing a wafer with the chemical rinse reducing defects on silicon and a dielectric, and maintaining integrity of a metal.

Certain embodiments of the invention have other aspects in addition to or in place of those mentioned or obvious from the above. The aspects will become apparent to those skilled in the art from a reading of the following detailed description when taken with reference to the accompanying drawings.

### BRIEF DESCRIPTION OF THE DRAWINGS

FIG. 1 is a plan view of a rinse system in an embodiment of the present invention;

FIG. 2 is a cross-sectional view of the wafer of the rinse system;

FIG. 3 is an isometric view of chemical rinse test coupons in an embodiment of the present invention;

FIG. 4 is an isometric view of chemical rinse test coupons in an embodiment of the present invention;

FIG. 5 is an isometric view of chemical rinse test coupons in an embodiment of the present invention;

FIG. 6 is a top view of a rinsed wafer section;

FIG. 7 is a top view of rinsed wafer sections in an embodiment of the present invention;

FIG. 8 is a top view of rinsed wafer sections;

FIG. 9 is a top view of rinsed wafer sections in an embodiment of the present invention; and

FIG. 10 is a flow chart of a rinse system for manufacturing the rinse system in an embodiment of the present invention.

### BEST MODE FOR CARRYING OUT THE INVENTION

In the following description, numerous specific details are given to provide a thorough understanding of the invention. However, it will be apparent that the invention may be practiced without these specific details. In order to avoid obscuring the present invention, some well-known circuits, and process steps are not disclosed in detail.

Likewise, the drawings showing embodiments of the apparatus/device are semi-diagrammatic and not to scale and, particularly, some of the dimensions are for the clarity of presentation and are shown greatly exaggerated in the drawing FIGs. Similarly, although the sectional views in the drawings for ease of description show the invention with surfaces as oriented downward, this arrangement in the FIGs. is arbitrary and is not intended to suggest that invention should necessarily be in a downward direction. Generally, the device can be operated in any orientation. In addition, the same numbers are used in all the drawing FIGs. to relate to the same elements.

The term “horizontal” as used herein is defined as a plane parallel to the conventional plane or surface of the invention, regardless of its orientation. The term “vertical” refers to a direction perpendicular to the horizontal as just defined. Terms, such as “on”, “above”, “below”, “bottom”, “top”, “side” (as in “sidewall”), “higher”, “lower”, “upper”, “over”, and “under”, are defined with respect to the horizontal plane. The term “on” refers to direct contact among the elements.

The term “processing” as used herein includes deposition of material or photoresist, patterning, exposure, development, etching, cleaning, and/or removal of the material or photoresist as required in forming a described structure.

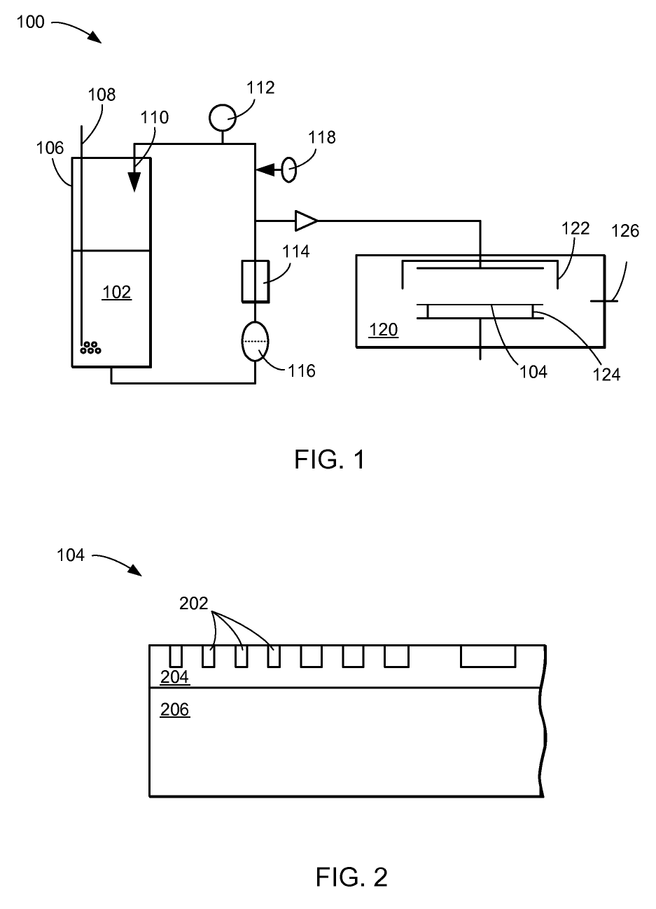

Referring now to FIG. 1, therein is shown a plan view of a rinse system 100 in an embodiment of the present invention. The rinse system 100 includes a chemical rinse 102 in a liquid medium. The chemical rinse 102 is applied over a wafer 104 for post-process cleaning and rinsing. The rinse system 100 uses the chemical rinse 102 instead of de-ionized water for rinsing the wafer 104. The chemical rinse 102 provides cleaning to reduce defects on the wafer 104 and corrosion inhibitors to maintain metal integrity, such as thickness, width, or depth. For metal film thickness or structures between 0.001 and 100 nm thick, wide, or deep, surface corrosion consumes a significant portion of the metal structure or film. Corrosion can result in missing or unusable lines, channels, dots, or arrays.

The chemical rinse 102 can include hydroxylamine or a derivative thereof (such as H₂NOH or R1R2NOR3 where R1, R2 or R3=H, CH₃, C₂H₅, C₃H₇, C₄H₉, C₅H₁₁, or C₆H₅), triazole or a derivative thereof (such as RC₇N₃H₄ where R=H, CH₃, C₂H₅, C₃H₇, C₄H₉, C₅H₁₁, C₆H₅, CO₂H, CH₂OH, CH₃S, C₂H₆N, C₄H₁₀N, CHO or C₂H₃O), an oxime (with the structure R1R2C=NOR3 where R1, R2 or R3=H, CH₃, C₂H₅, C₃H₇, C₄H₉, C₅H₁₁, or C₆H₅), de-ionized water with an inert gas (such as He, Ar, N₂, CO₂, methane), a silicon based corrosion inhibitor (such as SiR1R2R3R4, [NR1R2R3R4]₂SiO4, where R1, R2, R3, R4=H, CH₃, OCH₃, OC₂H₅, OC₃H₇, OC₄H9, Cl, F, Br, NC₂H₆, NC₄H₁₀, or NC₆H₁₄), a chelating molecule with N—O bonds (such as 2,3 Butane-dione, dioxime, C₄H₈N₂O₂), a sulfide (R1SR2 where R1 or R2=H, CH₃, C₂H₅, C₃H₇, C₄H₉, C₅H₁₁, or C₆H₅), a nitrite (RNO₂, where R=NH₄, NC₄H₁₂, CH₃, C₂H₅, C₃H₇, C₄H9 or C₅H₁₁), or any combination thereof.

The chemical rinse 102 can also include de-ionized water with in part or completely replaced dissolved gas, such as oxygen, carbon dioxide, nitrogen or a combination thereof, such as air. Dissolved gas can be removed by several processes, such as a vacuum, boiling, reacting with a chemical additive, absorbing using a gas absorbing material, using osmosis, using reverse osmosis, or displacement of the dissolved gas by purging, bubbling, or mixing with another gas. In addition to the chemical rinse 102, the rinse system 100 can also reduce defects on the wafer and inhibit corrosion by rinsing the wafer in a controlled environment. The controlled environment can include He, Ar, N₂, CO₂, methane, a vacuum, or a combination thereof. The controlled environment can also include a pressure controlled between a vacuum (10E-6 atmosphere) and 10 bar.

The rinse system 100 can include a tank 106 having an inlet 108, such as a gas inlet, and a return 110 for the chemical rinse 102. The rinse system 100 can also include a pressure-sensing device 112, a pump 114, a filter 116, and a valve 118, such as a needle valve. A circulating loop is provided with the tank 106, the pump 114, the filter 116, including an option to bubble saturate the chemical rinse 102 with a gas through the inlet 108. A rinse chamber 120 holds the wafer 104 for the chemical rinse 102 through front-side rinse nozzles 122. The rinse chamber 120 also includes backside rinse nozzles 124. As an option, a chamber gas purge 126 can be provided for the rinse chamber 120. A de-ionized water rinse system can be used or a separate system can be used to rinse the substrate with the chemical rinse 102.

Referring now to FIG. 2, therein is shown a cross-sectional view of the wafer 104 of the rinse system 100. The wafer 104 includes a metal 202, such as metal lines, and a dielectric 204 on a substrate 206, such as silicon. The substrate can include other semiconductor layers (not shown). The metal lines can be electrolessly or electrochemically deposited metal films or metal alloy films. The metal can be Copper, Ruthenium, Nickel, Cobalt, Iron, Palladium, Silver, Nickel, Boron, Tungsten, Tantalum, Molybdenum, Vanadium, Phosphorus or alloys thereof. It has been discovered that the chemical rinse 102 reduces defects on a surface of the dielectric 204 and a bare silicon surface of the substrate 206, and prevents corrosion on the metal 202.

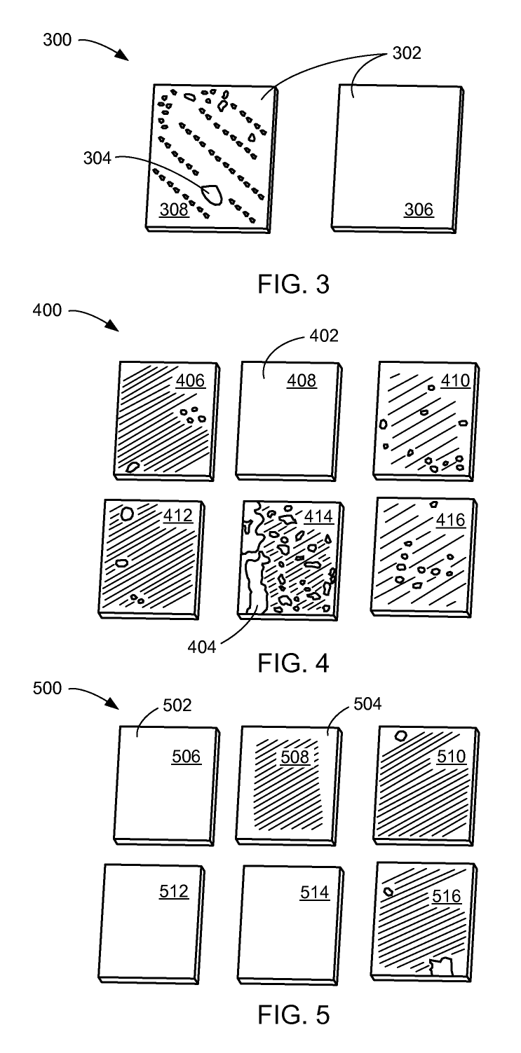

Referring now to FIG. 3, therein is shown an isometric view of chemical rinse test coupons 300 in an embodiment of the present invention. The chemical rinse test coupons 300 were cut from a silicon wafer (not shown) that was coated with approximately 13 nm of a cobalt-tungsten-boride layer 302 over a copper layer 304 deposited on the silicon wafer. The chemical rinse test coupons 300 include a hydroxylamine exposed coupon 306, rinsed with a hydroxylamine solution, and a de-ionized water exposed coupon 308, rinsed with de-ionized water. The de-ionized water exposed coupon 308 was exposed by submersion in de-ionized water for 200 minutes. The hydroxylamine exposed coupon 306 was submerged into a 1% solution of hydroxylamine or a derivative thereof, such as H₂NOH, in de-ionized water.

After 200 minutes, the hydroxylamine exposed coupon 306 and the de-ionized water exposed coupon 308 were removed and dried with clean, dry air. The results show that the de-ionized water has corroded the cobalt-tungsten-boride layer 302 to reveal the copper layer 304 on the de-ionized water exposed coupon 308. The hydroxylamine exposed coupon 306 does not shown signs of corrosion maintaining the integrity of the cobalt-tungsten-boride layer 302. It has been discovered that the chemical rinse 102 of FIG. 1 is compatible with electroless plated cobalt providing lower line-to-line leakage and thereby improving film integration.

Referring now to FIG. 4, therein is shown an isometric view of chemical rinse test coupons 400 in an embodiment of the present invention. In a manner similar to the chemical rinse test coupons 300, the chemical rinse test coupons 400 were cut from a silicon wafer (not shown) that was coated with approximately 13 nm of a cobalt-tungsten-boride layer 402 over a copper layer 404 deposited on a silicon wafer (not shown). The chemical rinse test coupons 400 include a 10% hydroxylamine exposed coupon 406, a 1% hydroxylamine exposed coupon 408, a 0.1% hydroxylamine exposed coupon 410, a 0.01% hydroxylamine exposed coupon 412, a 0.001% hydroxylamine exposed coupon 414, and a 0% hydroxylamine exposed coupon 416.

The chemical rinse test coupons 400 were immersed into six different chemical rinses with solutions of 10%, 1%, 0.1%, 0.01%, 0.001%, and 0% hydroxylamine or a derivative thereof, such as H₂NOH, in de-ionized water. The chemical rinse test coupons 400 were immersed for 180 minutes, removed, and dried with pressurized clean, dry air. The results show the 1% hydroxylamine exposed coupon 408 with no signs of corrosion, maintaining the integrity of the cobalt-tungsten-boride layer 402. The remaining coupons all show some corrosion of the cobalt-tungsten-boride layer 402 revealing a portion of the copper layer 404. It has been discovered that the chemical rinse 102 of FIG. 1 prevents corrosion of the cobalt-tungsten-boride layer 402.

Referring now to FIG. 5, therein is shown an isometric view of chemical rinse test coupons 500 in an embodiment of the present invention. In a manner similar to the chemical rinse test coupons 300, the chemical rinse test coupons 500 were cut from a silicon wafer (not shown) that was coated with approximately 13 nm of a cobalt-tungsten-boride layer 502 over a copper layer 504 deposited on the silicon wafer. The chemical rinse test coupons 500 include a 1% hydroxylamine with 1000 ppm triazole exposed coupon 506, a 1% hydroxylamine with 100 ppm triazole exposed coupon 508, a 1% hydroxylamine with 10 ppm triazole exposed coupon 510, a 0.1% hydroxylamine with 1000 ppm triazole exposed coupon 512, a 0.1% hydroxylamine with 100 ppm triazole exposed coupon 514, and a 0.1% hydroxylamine with 10 ppm triazole exposed coupon 516.

The chemical rinse test coupons 500 provide a full factorial design of experiment with solutions containing 1000 ppm, 100 ppm, and 10 ppm of triazole or a derivative thereof, such as Cobratech 939 or any chemical containing a six atom aromatic ring where three neighboring atoms are nitrogen and the remaining three are carbon, and 1%, 0.1% hydroxylamine or a derivative thereof, such as H₂NOH. The chemical rinse test coupons 500 were immersed for 4200 minutes, removed, and dried with pressurized clean, dry air. The results show that at 1% hydroxylamine or a derivative thereof, 1000 ppm of triazole or a derivative thereof is required to maintain the integrity of the cobalt-tungsten-boride layer 502. At 0.1% hydroxylamine or a derivative thereof, only 100 ppm of triazole or a derivative thereof is required to maintain the integrity of the cobalt-tungsten-boride layer 502.

It has been unexpectedly discovered that there is an unusual synergistic effect between triazole or a derivative thereof and hydroxylamine or a derivative thereof wherein less of triazole or a derivative thereof is required to prevent corrosion if less of hydroxylamine or a derivative thereof is used. Further, it has been discovered that triazole or a derivative thereof is more effective in combination with hydroxylamine or a derivative thereof within a range of 0.01% to 10% hydroxylamine or a derivative thereof and 100 ppm to 10,000 ppm of triazole or a derivative thereof in de-ionized water.

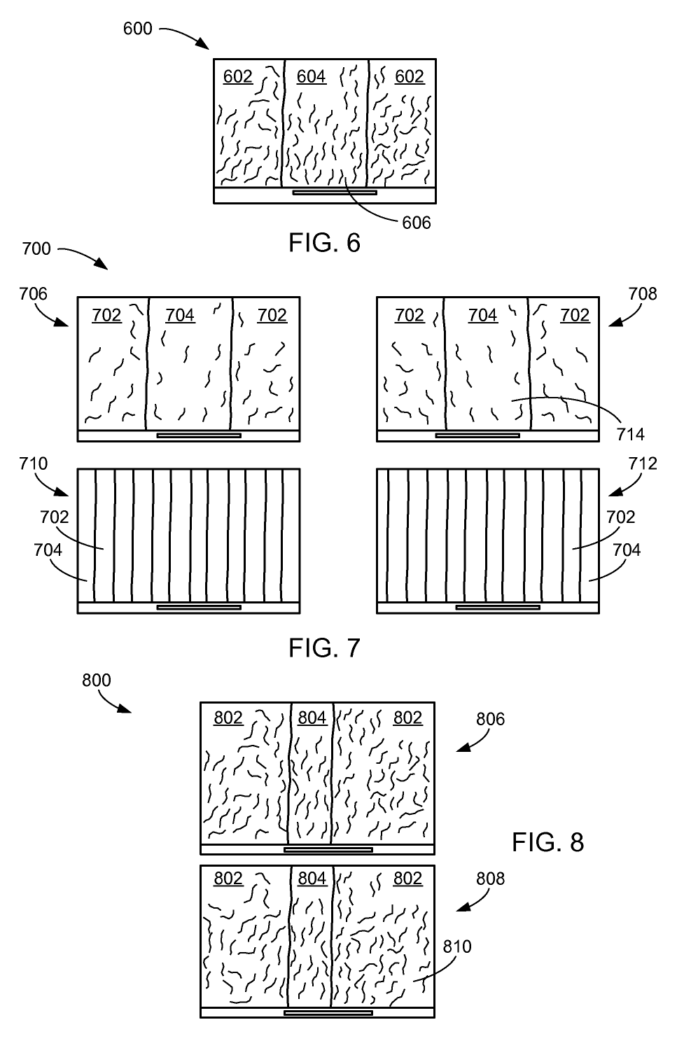

Referring now to FIG. 6, therein is shown a top view of a rinsed wafer section 600. The rinsed wafer section 600 includes a metal 602, such as copper, and a dielectric 604, such as silicon dioxide. The rinsed wafer section 600 was rinsed with de-ionized water having dissolved oxygen (not shown). The metal 602 and the dielectric 604 show significant defects 606, such as string residue. The de-ionized water having dissolved oxygen did not clean the residue and the defects 606 on the dielectric 604 and the metal 602.

Referring now to FIG. 7, therein is shown a top view of rinsed wafer sections 700 in an embodiment of the present invention. The rinsed wafer sections 700 include a metal 702, such as copper, and a dielectric 704, such as silicon dioxide. The rinsed wafer sections 700 were rinsed with de-ionized water having dissolved oxygen (not shown) replaced by nitrogen gas (not shown). The rinse chamber 120 of FIG. 1 was purged with nitrogen gas to replace air (not shown) and oxygen. The remaining oxygen was less than 15%. A rinsed wafer center section 706, a rinsed wafer edge section 708, a larger view wafer center section 710, and a larger view wafer edge section 712 show reduced defects 714, such as string residue. The de-ionized water having dissolved oxygen partly replaced by nitrogen gas significantly reduced the residue and the defects 714 on the dielectric 604 and the metal 602.

Referring now to FIG. 8, therein is shown a top view of rinsed wafer sections 800. The rinsed wafer sections 800 include a metal 802, such as copper, and a dielectric 804, such as silicon dioxide. The rinsed wafer sections 800 including a rinsed wafer center section 806 and a rinsed wafer edge section 808 were rinsed with de-ionized water without chemicals. The metal 802 and the dielectric 804 show significant defects 810, such as string residue. The de-ionized water without chemicals did not clean the residue and the defects 810 on the dielectric 804 and the metal 802.

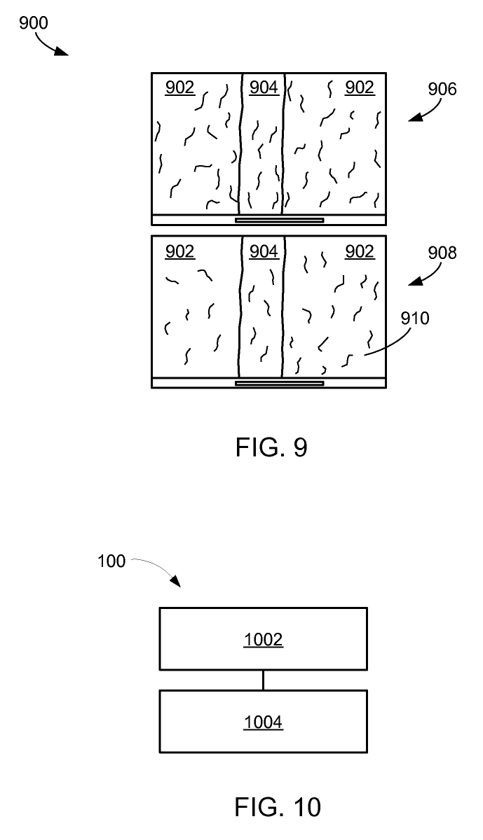

Referring now to FIG. 9, therein is shown a top view of rinsed wafer sections in an embodiment of the present invention. The rinsed wafer sections 900 include metal 902, such as copper, and a dielectric 904, such as silicon dioxide. The rinsed wafer sections 900 were rinsed with a 1% hydroxylamine or a derivative thereof solution (not shown). A rinsed wafer center section 906 and a rinsed wafer edge section 908 show reduced defects 910, such as string-like residue. The de-ionized water having dissolved oxygen partly replaced by nitrogen gas significantly reduced the residue and the defects 910 on the dielectric 904 and the metal 902. An Auger surface scan shows that cobalt impurities of the defects 910 were reduced to 7.1% from 21.8% of the rinsed wafer sections 800 of FIG. 8 rinsed with de-ionized water without chemicals.

Referring now to FIG. 10 is a flow chart of a rinse system 1000 for manufacturing the rinse system 100 in an embodiment of the present invention. The system 1000 includes providing a chemical rinse including a corrosion inhibitor in a block 1002; and rinsing a wafer with the chemical rinse reducing defects on silicon and a dielectric, and maintaining integrity of a metal in a block 1004.

In greater detail, a method to fabricate the rinse system 100, in an embodiment of the present invention, is performed as follows:
1. Providing a rinse device. (FIG. 1)
2. Mixing a chemical rinse including a corrosion inhibitor in the rinse device. (FIG. 1)
3. Rinsing a wafer with the chemical rinse reducing defects on silicon and a dielectric, and maintaining integrity of a metal. (FIG. 1)

It has been discovered that the present invention thus has numerous aspects.

An aspect is that present invention provides a rinse that does not corrode metal. The major chemical constituent is generally de-ionized water. The de-ionized water contains <10% of a chemical that lowers the corrosion rate of the metal compared to that in de-ionized water. The chemistry can be vaporized such as hydroxylamine, ammonia, amines, and alcohols. In addition, a small amount of corrosion inhibitor may be added such a triazole and its derivatives.

Another aspect is that the present invention provides alternate solvents. The chemical rinse can include alternate solvents that can be used instead of de-ionized water. Some of the alternate solvents include non-water based solvents such as alcohols, supercritical CO₂, organic solvents and liquefied gases (butane, carbon dioxide) or mixtures of any of these with de-ionized water.

Yet another aspect is that the present invention provides a controlled environment that reduces metal corrosion. Alternatively, the atmosphere where the substrate resides can be controlled to contain a gaseous composition that reduces metal corrosion. An example is an environment purged with an inert gas such as nitrogen, argon, helium, carbon dioxide, or methane. The rinse can also include gases such as nitrogen, argon, helium, carbon monoxide, methane, or other gaseous hydrocarbon in the chemical rinse replacing the dissolved gases, such as oxygen, carbon dioxide, nitrogen or a combination thereof, such as air.

It has been discovered that the disclosed structure provides an extended rinse time. De-ionized water corrodes certain metals such as copper and cobalt resulting in short rinses with limited particle performance and relatively high metal contamination on dielectric surfaces of patterned wafers, where the surface is composed of a combination of metal and dielectric materials. The disclosed structure is compatible many metals including copper and cobalt resulting in significantly longer rinse times.

It has also been discovered that the disclosed structure provides less metal contamination. Metal being lifted off the metal surface is deposited on bare silicon or dielectric surfaces. The disclosed structure is a non-corrosive chemical rinse such that improved particle performance can be achieved and in the case of patterned wafers, the dielectric areas have a lower amount of metal contamination.

Yet another discovery of the disclosed structure is that it provides a cleaner metal surface. The disclosed structure prevents corrosion of thin metal films during rinse processes after wafer processing. The improved rinse times and corrosion inhibition provide significantly cleaner metal surfaces by removing more residue and contaminants.

Yet another discovery of the disclosed structure is that it provides fewer defects on the metal surface. The improved anti-corrosion and cleaning performance of the disclosed structure removes more residue and does not corrode the metal surface. The defects from corrosion and residue on the metal surface are significantly reduced.

Yet another discovery of the disclosed structure provides retaining the deposited thickness of the metal. The improved anti-corrosion significantly reduces metal loss due to corrosion of the metal surface. The integrity of the metal including the deposited thickness is retained.

Yet another discovery of the disclosed structure provides compatibility with electroless plated cobalt providing lower line-to-line leakage and thereby improving film integration. The disclosed structure improves cleaning and corrosion inhibition for many metals including cobalt. Retaining the integrity of cobalt films provides performance enhancement to the metal lines.

Yet another discovery of the disclosed structure provides a smaller amount of corrosion inhibitors. The disclosed structure provides a reduced amount of corrosion inhibitors when used in combination with other chemicals. A combination of chemicals allows significantly reduced quantities required for corrosion inhibitors while improving cleaning and anti-corrosion performance.

Yet another discovery of the disclosed structure is that it provides compatibility with standard rinse systems. While the disclosed structure uses a chemical mixture instead of de-ionized water (DIW) for rinsing, the chemical mixture can be applied in a standard DIW rinse system. A separate system can also be introduced to rinse the wafer with or without a standard DIW rinse system.

These and other valuable aspects of the present invention consequently further the state of the technology to at least the next level.

Thus, it has been discovered that the non-corrosive chemical rinse system method and apparatus of the present invention furnish important and heretofore unknown and unavailable solutions, capabilities, and functional aspects. The resulting processes and configurations are straightforward, cost-effective, uncomplicated, highly versatile, and effective, can be implemented by adapting known technologies, and are thus readily suited for efficient and economical manufacturing.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations, which fall within the scope of the included claims. All matters hithertofore set forth herein or shown in the accompanying drawings are to be interpreted in an illustrative and non-limiting sense.

What is claimed is:

1. A rinse system comprising:
providing a chemical rinse including a corrosion inhibitor; and
rinsing a wafer with the chemical rinse reducing defects on silicon and a dielectric, and maintaining metal integrity.

2. The system as claimed in claim 1 wherein providing the chemical rinse comprises mixing 0.01% to 10% hydroxylamine or a derivative thereof and 100 ppm to 10,000 ppm of triazole or a derivative thereof in water.

3. The system as claimed in claim 1 wherein providing the chemical rinse comprises mixing de-ionized water having in part or completely replaced dissolved gas, such as oxygen, carbon dioxide, nitrogen or a combination thereof, such as air.

4. The system as claimed in claim 1 wherein providing the chemical rinse comprises applying a vacuum, boiling, reacting with a chemical additive, adsorbing using a gas adsorbing material, using osmosis, or using reverse osmosis, to remove dissolved gas.

5. A rinse system comprising:
a chemical rinse including a corrosion inhibitor; and
a wafer rinsed with the chemical rinse reducing defects on silicon and a dielectric, and maintaining metal integrity.

6. The system as claimed in claim 5 wherein the chemical rinse comprises hydroxylamine or a derivative thereof in water in a concentration of 0.01-10% for a rinse of a metal containing substrate.

7. The system as claimed in claim 5 wherein the chemical rinse comprises hydroxylamine or a derivative thereof in water in a concentration of 0.3-3% for a rinse of a metal containing substrate.

8. The system as claimed in claim 5 wherein the chemical rinse comprises triazole or a derivative thereof in water in a concentration of 10-1000 ppm for preventing corrosion of a metal containing substrate.

9. The system as claimed in claim 5 wherein the chemical rinse comprises hydroxylamine or a derivative thereof such as H₂NOH or R1R2NOR3 where R1, R2 or R3=H, CH₃, C₂H₅, C₃H₇, C₄H₉, C₅H₁₁, or C₆H₅.

10. The system as claimed in claim 5 wherein the chemical rinse comprises triazole or a derivative thereof such as RC₇N₃H₄ where R=H, CH₃, C₂H₅, C₃H₇, C₄H₉, C₅H₁₁, C₆H₅, CO₂H, CH₂OH, CH₃S, C₂H₆N, C₄H₁₀N, CHO or C₂H₃O.

11. The system as claimed in claim 5 wherein the chemical rinse comprises an oxime, with the structure R1R2C=NOR3 where R1, R2 or R3=H, CH₃, C₂H₅, C₃H₇, C₄H₉, C₅H₁₁, or C₆H₅.

12. The system as claimed in claim 5 wherein the chemical rinse comprises an inert gas such as He, Ar, N₂, CO₂, methane, that has in part or completely replaced dissolved gas in de-ionized water.

13. The system as claimed in claim 5 wherein the chemical rinse comprises a silicon based corrosion inhibitor such as SiR1R2R3R4, [NR1R2R3R4]₂SiO₄, where R1, R2, R3, R4=H, CH₃, OCH₃, OC₂H₅, OC₃H₇, OC₄H₉, Cl, F, Br, NC₂H₆, NC₄H₁₀, or NC₆H₁₄.

14. The system as claimed in claim 5 wherein the chemical rinse comprises a chelating molecule with N—O bonds such as 2,3 Butane-dione, dioxime (C₄H₈N₂O₂).

15. The system as claimed in claim 5 wherein the chemical rinse comprises a sulfide, R1SR2 where R1 or R2=H, CH₃, C₂H₅, C₃H₇, C₄H₉, C₅H₁₁, or C₆H₅.

16. The system as claimed in claim 5 wherein the chemical rinse comprises a nitrite, RNO₂, where R=NH₄, NC₄H₁₂, CH₃, C₂H₅, C₃H₇, C₄H₉ or C₅H₁₁.

17. A rinse system comprising:
a rinse device;
a chemical rinse including a corrosion inhibitor in the rinse device; and
a wafer rinsed with the chemical rinse reducing defects on silicon and a dielectric, and maintaining metal integrity.

18. The system as claimed in claim 17 wherein the metal comprises copper, cobalt, silicon, ruthenium, tantalum, tungsten, molybdenum, boron, phosphorus, or alloys thereof.

19. The system as claimed in claim 17 wherein the wafer comprises the wafer rinsed in an environment of He, Ar, N₂, CO₂, methane, a vacuum or a combination thereof where the pressure is controlled between a vacuum and 10 bar.

20. The system as claimed in claim 17 wherein the rinse device comprises an inlet for saturating the chemical rinse with a gas, and a chamber gas purge for providing a controlled atmosphere.
